(19) United States
(12) Patent Application Publication
(10) Pub. No.: US 2022/0161755 A1
(43) Pub. Date: May 26, 2022

(54) WEBBING TAKE-UP DEVICE

(71) Applicant: KABUSHIKI KAISHA TOKAI-RIKA-DENKI-SEISAKUSHO, Aichi (JP)

(72) Inventors: Chihiro MATSUOKA, Aichi (JP); Atsushi NISHINO, Aichi (JP); Motoki SUGIYAMA, Aichi (JP); Kazuhiro YAMADA, Aichi (JP)

(21) Appl. No.: 17/441,460

(22) PCT Filed: Mar. 30, 2020
(86) PCT No.: PCT/JP2020/014551

§ 371 Date: Sep. 21, 2021

(30) Foreign Application Priority Data
Apr. 9, 2019 (JP) 2019-074161
Dec. 17, 2019 (JP) 2019-227053

(51) Int. Cl. B60R 22/343; B60R 22/41

(52) U.S. Cl. CPC B60R 22/343; B60R 22/41

(57) ABSTRACT

Unnecessary locking of rotation of a spool is suppressed. A webbing take-up device is provided with a spool, a pawl and a small pawl. The pawl is displaceable between an allowing position and a locking position. When a rotation speed of the spool in a pull-out direction exceeds a predetermined speed, the pawl displaces from the allowing position to the locking position and locks rotation of the spool in the pull-out direction. The small pawl is displaceable between a pawl limiting position and a lock position. In a state in which the small pawl is disposed at the pawl limiting position, the small pawl limits displacement of the pawl to a locking position side thereof. In a state in which the small pawl is disposed at the lock position, the small pawl locks rotation of the spool in the pull-out direction.

### TECHNICAL FIELD

The present invention relates to a webbing take-up device.

### BACKGROUND ART

Japanese Patent Application Laid-Open (JP-A) No. 2012-192854 and European Patent Application Publication No. 460494 disclose webbing take-up devices equipped with a lock mechanism that limits pulling out of a webbing from a spool at a time of rapid deceleration of a vehicle or when the webbing is suddenly pulled out from the spool.

In the lock mechanism of the webbing take-up device recited in JP-A No. 2012-192854, rotation of the spool is locked by an inertial ball moving at a time of rapid deceleration of the vehicle, and pulling out of the webbing from the spool is restricted.

In the lock mechanism of the webbing take-up device recited in European Patent Application Publication No. 460494, a pawl to which a permanent magnet is fixed engages with inner teeth of a blocking component, and locking teeth engage with a housing pawl. Thus, rotation of the spool is locked, and pulling out of the webbing from the spool is restricted. In the webbing device recited in this Reference, the pawl to which the permanent magnet is fixed is displaced toward a side thereof at which the inner teeth of the blocking component are disposed by electric current being applied to a coil of an electromagnet.

The webbing take-up devices recited in the References mentioned above are provided with mechanisms that suppress unnecessary locking of rotation of the spool by the lock mechanism, by limiting displacement of the inertial ball, W pawl or pawl.

### SUMMARY OF INVENTION

### Technical Problem

In consideration of the circumstances described above, the present invention provides a webbing take-up device that may suppress unnecessary locking of rotation of a spool.

### Solution to Problem

A webbing take-up device according to a first aspect includes: a spool onto which is taken up a webbing that is configured to be applied to a vehicle occupant, the spool being rotated in a pull-out direction by the webbing being pulled out; a first pawl provided to be integrally rotatable with the spool, the first pawl being displaceable between an allowing position and a locking position, and in a case in which a rotation speed of the spool in the pull-out direction exceeds a predetermined speed, the first pawl being displaced from the allowing position to the locking position and locking rotation of the spool in the pull-out direction; and a second pawl provided to be integrally rotatable with the spool, the second pawl being displaceable between a first position and a second position, in a state in which the second pawl is disposed at the first position, the second pawl limiting displacement of the first pawl to the locking position side thereof, and in a state in which the second pawl is disposed at the second position, the second pawl locking rotation of the spool in the pull-out direction.

In a webbing take-up device according to a second aspect, the webbing take-up device according to the first aspect further includes an engaged portion disposed at an outer side in a spool diameter direction of the first pawl and the second pawl, the first pawl and the second pawl engaging with the engaged portion. The first pawl engages with the engaged portion in a case in which the first pawl is disposed at the locking position, and the second pawl engages with the engaged portion in a case in which the second pawl is disposed at the second position.

In a webbing take-up device according to a third aspect, the webbing take-up device according to the first aspect or the second aspect further includes: a magnet provided at the second pawl; and a coil disposed to oppose the magnet. The second pawl is displaced to the first position by electric current being applied to the coil in one direction, and the second pawl is displaced to the second position by electric current being applied to the coil in the other direction.

In a webbing take-up device according to a fourth aspect, in the webbing take-up device according to any one of the first to third aspects, the second pawl is disposed at a middle position between the first position and the second position and allows displacement of the first pawl to the locking position side thereof.

In a webbing take-up device according to a fifth aspect, the webbing take-up device according to the fourth aspect further includes an urging member that urges the second pawl that has been displaced to a first position side or a second position side to a middle position side thereof.

In a webbing take-up device according to a sixth aspect, in the webbing take-up device according to any one of the third to fifth aspects, the coil and the magnet are disposed adjacent to each other in a rotation axis direction of the spool.

In a webbing take-up device according to a seventh aspect, in the webbing take-up device according to the fourth aspect or the fifth aspect, the first position to which the second pawl displaces is at one side in a spool circumference direction and the second position to which the second pawl displaces is at an opposite side from the one side in the spool circumference direction, relative to the middle position.

### Advantageous Effects of Invention

In the webbing take-up device according to the first aspect, in a case in which the rotation speed of the spool in the pull-out direction exceeds the predetermined speed, the first pawl displaces from the allowing position to the locking position. Hence, rotation of the spool in the pull-out direction is locked, and pulling out of the webbing from the spool is limited.

In the state in which the second pawl is disposed at the first position, displacement of the first pawl to the locking position side thereof is limited. Thus, unnecessary locking of rotation of the spool is avoided or suppressed. In this state, pulling out of the webbing from the spool is allowed.

In the state in which the second pawl is disposed at the second position, rotation of the spool in the pull-out direction is locked. Thus, pulling out of the webbing from the spool is limited.

In the webbing take-up device according to the second aspect, the first pawl and the second pawl are structured to engage with the same engaged portion, which is disposed at the outer side in the spool diameter direction of the first pawl and the second pawl. Therefore, an increase in overall size of the webbing take-up device may be suppressed compared to a structure in which respective engaged portions with which the first pawl and the second pawl engage are provided.

In the webbing take-up device according to the third aspect, when electric current is applied to the coil in the one direction, the second pawl is displaced to the first position by interaction between the current flowing through the coil and the magnetic field of the magnet. As a result, displacement of the first pawl to the locking position side thereof is limited, and unnecessary locking of the rotation of the spool is avoided or suppressed. In this state, pulling out of the webbing from the spool is allowed.

When electric current is applied to the coil in the other direction, the second pawl is displaced to the second position by interaction between the current flowing through the coil and the magnetic field of the magnet. Hence, rotation of the spool in the pull-out direction is locked, and pulling out of the webbing from the spool is limited.

In the webbing take-up device according to the fourth aspect, the second pawl can be disposed at the middle position between the first position and the second position. In this state, displacement of the first pawl to the locking position side thereof is allowed. That is, when the rotation speed of the spool in the pull-out direction exceeds the predetermined speed, the first pawl is displaced from the allowing position to the locking position. Hence, rotation of the spool in the pull-out direction is locked, and pulling out of the webbing from the spool is limited.

In the webbing take-up device according to the fifth aspect, the urging member is provided that, in a case in which the second pawl has been displaced to the first position side or second position side thereof, urges the second pawl to the middle position side thereof. Therefore, the second pawl may be retained at the middle position simply.

In the webbing take-up device according to the sixth aspect, because the coil and the magnet are disposed adjacent to one another in the rotation axis direction of the spool, an increase in overall size of the webbing take-up device in a diameter direction (the diameter direction of the spool) may be suppressed.

In the webbing take-up device according to the seventh aspect, the second pawl is displaced from the middle position to the one side in the spool circumference direction and to the opposite side from the one side in the spool circumference direction, to control rotation of the spool. Therefore, a range of displacement of the second pawl may be made compact and an increase in overall size of the webbing take-up device may be suppressed.

### BRIEF DESCRIPTION OF DRAWINGS

FIG. 1 is an exploded perspective view showing disassembly of a webbing take-up device according to a present exemplary embodiment in a view seen from a side at which a lock mechanism is disposed.

FIG. 2 is an exploded perspective view showing disassembly of the webbing take-up device according to the present exemplary embodiment in a view seen from the opposite side from the side thereof at which the lock mechanism is disposed.

FIG. 3 is a plan view showing the lock mechanism in a state in which a small pawl limits displacement of a W pawl.

FIG. 4 is a plan view showing the lock mechanism in a state in which the small pawl is engaged with a sensor holder.

FIG. 5 is a plan view showing the lock mechanism in a state in which the small pawl is disposed at a middle position.

FIG. 6 is a plan view showing a lock mechanism according to an alternative embodiment in a state in which a small pawl limits displacement of a W pawl.

FIG. 7 is a plan view showing the lock mechanism according to the alternative embodiment in a state in which the small pawl is engaged with a sensor holder.

FIG. 8 is a plan view showing the lock mechanism according to the alternative embodiment in a state in which the small pawl is disposed at a middle position.

FIG. 9 is a plan view showing the lock mechanism according to the alternative embodiment, depicting superimposed positions of the small pawl and a torsion coil spring in the states shown in FIG. 6, FIG. 7 and FIG. 8.

FIG. 10 is a plan view showing a lock mechanism according to another alternative embodiment in a state in which a small pawl limits displacement of a W pawl.

FIG. 11 is a plan view showing the lock mechanism according to another alternative embodiment in a state in which the small pawl is engaged with a sensor holder.

FIG. 12 is a plan view showing the lock mechanism according to another alternative embodiment in a state in which the small pawl is disposed at a middle position

FIG. 13 is a side view showing a small pawl in which a weight is embedded.

FIG. 14 is a sectional diagram showing a section in which a region in which a lock mechanism is provided is cut in an axis direction.

### DETAILED DESCRIPTION

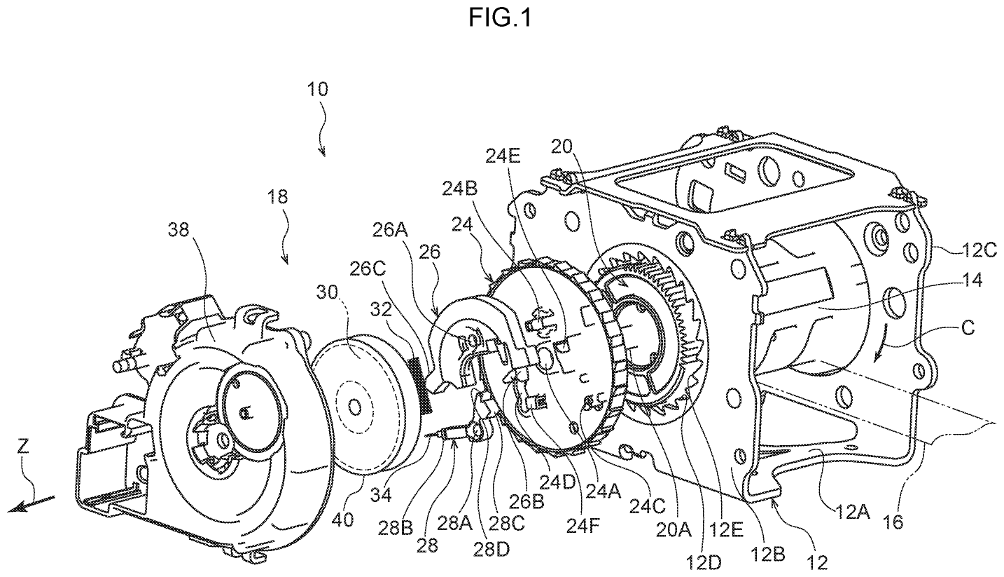

A webbing take-up device according to an exemplary embodiment of the present invention is described using FIG. 1 to FIG. 5.

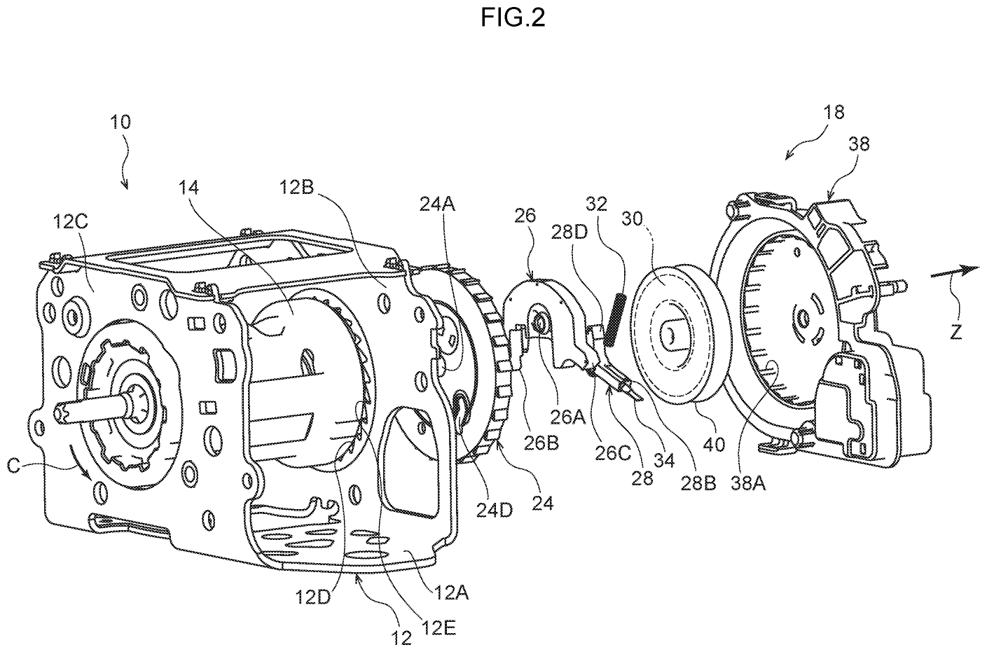

As shown in FIG. 1 and FIG. 2, a webbing take-up device 10 according to the present exemplary embodiment is provided with a frame 12, a spool 14, a webbing 16 and a lock mechanism 18. Where simply an axis direction, diameter direction and circumference direction are referred to below without being particularly specified, these refer to the rotation axis direction, rotation diameter direction and rotation circumference direction of the spool.

The frame 12 is provided with a plate-shaped back plate 12A that is fixed to a vehicle body. Leg plates 12B and 12C protrude substantially perpendicularly from both of width direction (axis direction) end portions of the back plate 12A. The lock mechanism 18, which is described below, is provided at a side of the frame 12 at which the leg plate 12B is disposed. An aperture 12D is formed in the leg plate 12B. A lock base 20 and a main lock 22, which are described below, are disposed at an inner periphery portion of the aperture 12D. Plural lock teeth 12E are formed along the circumference direction at an inner edge of the aperture 12D. The main lock 22 engages with the lock teeth 12E. A take-up urging mechanism, which is not shown in the drawings, is provided at a side of the frame 12 at which the leg plate 12C is disposed. The take-up urging mechanism urges the spool 14 to rotate in a take-up direction.

The spool 14 is formed substantially in a circular tube shape. The spool 14 is rotatably supported at the frame 12 between the leg plate 12B and the leg plate 12C of the frame 12. A publicly known torsion shaft constituting a force limiter mechanism is disposed inside the spool 14. As shown in FIG. 1, the lock base 20 is provided at an end portion in an axis direction one side (the side in the direction of arrow Z) of the spool 14. The lock base 20 is coupled to the spool 14 via the torsion shaft, which is not shown in the drawings. A V gear support portion 20A is provided standing toward the axis direction one side from a diameter direction central portion of the lock base 20. A V gear 24, which is described below, is supported at the V gear support portion 20A.

The webbing 16 is to be applied to the body of a vehicle occupant. A base end portion of the webbing 16, which is a length direction one end portion, is anchored at the spool 14. A spiral spring constitutes a portion of the take-up urging mechanism. The spool 14 is urged to rotate in the take-up direction, which is one rotation direction (the direction of arrow C in FIG. 1 and the like), by urging force of the spiral spring. When the spool 14 rotates in the take-up direction, the webbing is taken up onto the spool 14 starting from the base end side of the webbing. When the webbing is pulled out from the spool 14, the spool 14 is turned in a pull-out direction, which is the other rotation direction (the opposite direction from arrow C in FIG. 1 and the like).

Now the lock mechanism 18, which is a principal portion of the present exemplary embodiment, is described.

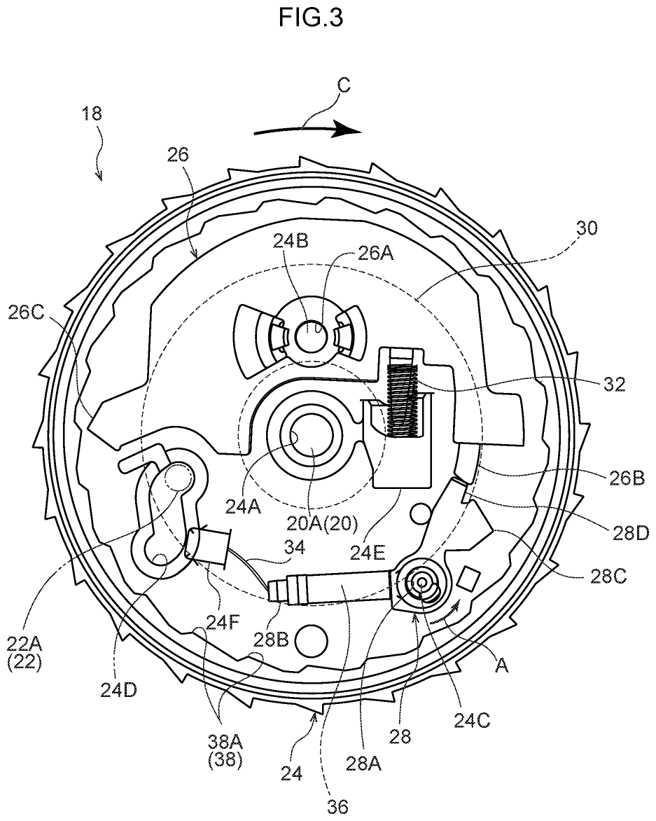

As shown in FIG. 1 and FIG. 2, the lock mechanism 18 is structured with the main lock 22 (see FIG. 3), the V gear 24, a W pawl 26, a small pawl 28 and a coil 30 serving as the major principal portions thereof. The main lock 22 is supported at the lock base 20. The V gear 24 is rotatably supported at the lock base 20. The W pawl 26 and the small pawl 28 are supported at the V gear 24. The W pawl 26 serves as a first pawl and the small pawl 28 serves as a second pawl.

The main lock 22 is formed in a substantially rectangular block shape. A proximal end side of the main lock 22 is tiltably supported at a main lock support portion that is provided at the lock base 20. Main lock-side engaging teeth are formed at a diameter direction outer side of a distal end of the main lock 22. The main lock-side engaging teeth engage with the lock teeth 12E of the frame 12. The structure of the main lock 22 is similar to publicly known structures. Accordingly, descriptions using diagrams of the proximal end side of the main lock 22, the main lock-side engaging teeth at a distal end side and the like are not given here. When the main lock 22 is tilted (displaced) to the diameter direction outer side, with the main lock support portion acting as a spindle, the main lock-side engaging teeth engage with the lock teeth 12E of the frame 12. As shown in FIG. 3, a V gear engaging protrusion 22A is formed at the main lock 22. The V gear engaging protrusion 22A protrudes to one side in the axis direction.

The V gear 24 is formed in a circular plate shape. A support hole 24A is formed at an diameter direction center of the V gear 24. The V gear support portion 20A provided at the rotation center of the lock base 20 (see FIG. 1) is inserted through the support hole 24A. Because the V gear support portion 20A of the lock base 20 is inserted through the support hole 24A, the V gear 24 is rotatable with the V gear support portion 20A acting as a spindle.

A W pawl support portion 24B supports the W pawl 26, which is described below. The W pawl support portion 24B is provided standing to the axis direction one side at an outer side in the diameter direction of a region of the V gear 24 in which the support hole 24A is formed. A small pawl support portion 24C supports the small pawl 28, which is described below. The small pawl support portion 24C is provided standing to the axis direction one side at an outer side in the diameter direction of the region of the V gear 24 in which the support hole 24A is formed. The small pawl support portion 24C is provided at one side in the circumference direction of a region in which the W pawl 26, which is supported at the W pawl support portion 24B, is disposed. An operation slot 24D with a long hole shape is formed at an outer side in the diameter direction of the region of the V gear 24 in which the support hole 24A is formed. The operation slot 24D is formed at a region that does not overlap in the axis direction with the W pawl 26, which is supported at the W pawl support portion 24B, or with the small pawl 28, which is supported at the small pawl support portion 24C. The V gear engaging protrusion portion 22A of the main lock 22 is disposed inside the operation groove 24D. A spring, which is not shown in the drawings, is provided between the V gear 24 and the lock base 20. The V gear 24 described above is urged to rotate in the pull-out direction relative to the lock base 20 by this spring, and rotation of the V gear 24 in the pull-out direction relative to the lock base 20 is stopped by the spring.

The W pawl 26 is formed in a block shape, which is substantially a half-moon shape as seen in the axis direction. A support hole 26A is formed in the W pawl 26 at a middle portion thereof in the circumference direction and the diameter direction. The W pawl support portion 24B of the V gear 24 is inserted through the support hole 26A. Because the W pawl support portion 24B of the V gear 24 is inserted through the support hole 26A, the W pawl 26 is tiltable (displaceable) with the W pawl support portion 24B acting as a spindle.

A coil spring 32 that urges the W pawl 26 is engaged with one side in the circumference direction (the side in the direction of arrow C) of the W pawl 26. The coil spring 32 is compressed between the W pawl 26 and a coil spring anchoring portion 24E provided at the V gear 24. A small pawl-abutting portion 26B protrudes to the circumference direction one side (the side in the direction of arrow C) from an end portion at the circumference direction one side of the W pawl 26. The small pawl-abutting portion 26B abuts against the small pawl 28, which is described below.

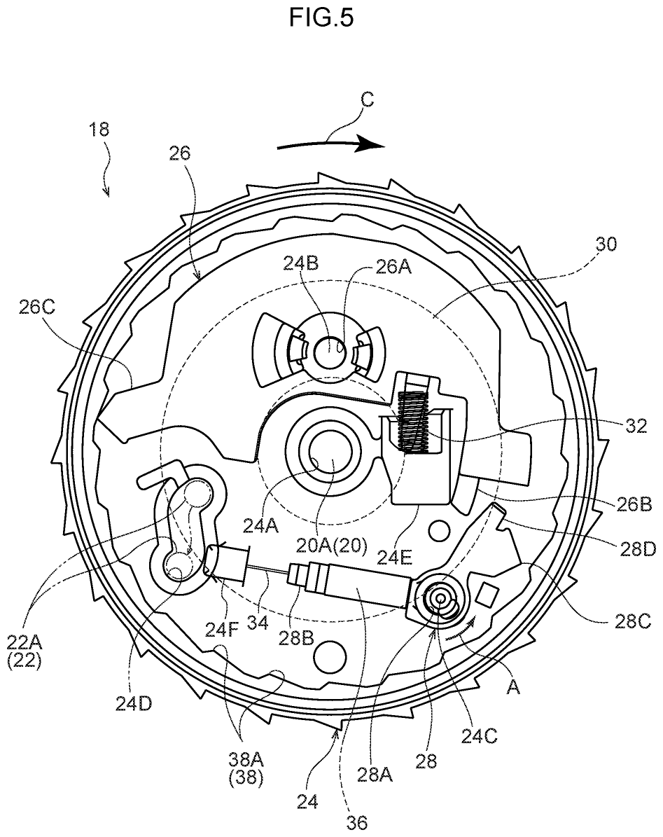

A single W pawl side engaging tooth 26C is formed at an end portion at the other side in the circumference direction (the opposite side from the direction of arrow C) of the W pawl 26. The W pawl side engaging tooth 26C engages with pawl engaging teeth 38A formed at a sensor holder 38, which is described below. When the W pawl 26 tilts to one side in opposition to the urging force of the coil spring 32 with the W pawl support portion 24B of the V gear 24 acting as a spindle (tilts such that the side of the W pawl 26 at which the W pawl side engaging tooth 26C is provided displaces to the diameter direction outer side), as shown in FIG. 5, the W pawl side engaging tooth 26C engages with the pawl engaging teeth 38A of the sensor holder 38. Note that a position of the W pawl 26 in a state in which tilting of the W pawl 26 is limited by the urging force of the coil spring 32 serves as an “allowing position”, and a position of the W pawl 26 in the state in which the W pawl side engaging tooth 26C may engage with the pawl engaging teeth 38A of the sensor holder 38 serves as a “locking position”. In the present exemplary embodiment, when a rotation speed of the spool 14 in the pull-out direction exceeds a predetermined speed, centrifugal force acting on the W pawl 26 exceeds the urging force of the coil spring 32 and the W pawl 26 tilts to the one side.

As shown in FIG. 3, the small pawl 28 is formed in an L-shaped block shape that is smaller than the W pawl 26. A support hole 28A is formed at the small pawl 28 at a middle portion thereof in the circumference direction. The small pawl support portion 24C of the V gear 24 is inserted through the support hole 28A. Because the small pawl support portion 24C of the V gear 24 is inserted through the support hole 28A, the small pawl 28 is tiltable (displaceable) with the small pawl support portion 24C acting as a spindle.

An end portion at one side in the circumference direction (the side in the direction of arrow C) of the small pawl 28 is formed as a plate spring anchoring portion 28B. An end portion at one side of a plate spring 34 is anchored at the plate spring anchoring portion 28B. The plate spring 34 serves as an urging member that urges the small pawl 28 to a middle position side thereof, which is described below. An end portion at the other side of the plate spring 34 is anchored at a plate spring anchoring portion 24F, which is provided at the V gear 24.

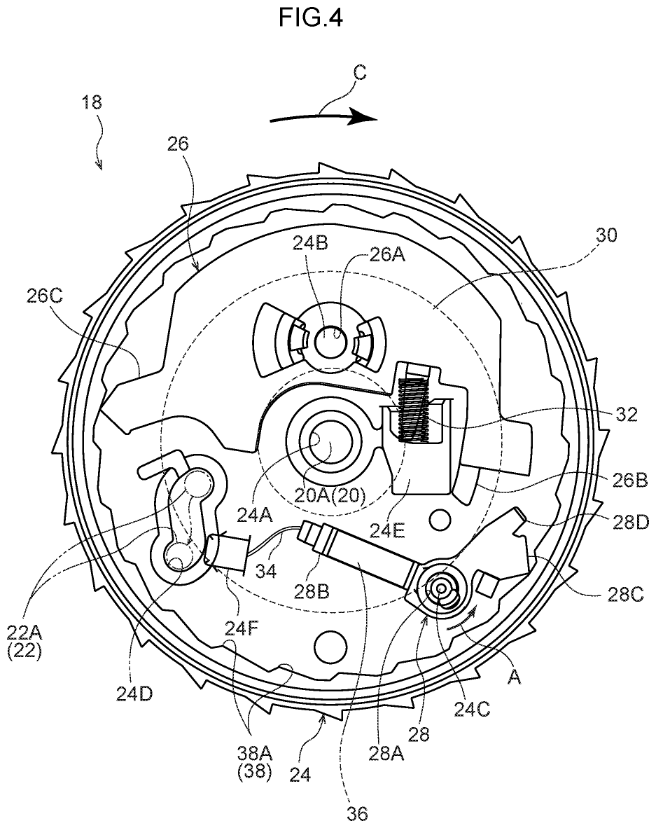

A single small pawl side engaging tooth 28C is provided at an outer side in the diameter direction of the small pawl 28. The single small pawl side engaging tooth 28C is provided at an end portion at the other side in the circumference direction (the opposite side from the direction of arrow C). The small pawl side engaging tooth 28C engages with the pawl engaging teeth 38A formed at the sensor holder 38, which is described below. When the small pawl 28 tilts to one side (the side in the opposite direction from arrow A) in opposition to urging force of the plate spring 34 with the small pawl support portion 24C of the V gear 24 acting as a spindle (tilts such that the side of the small pawl 28 at which the small pawl side engaging tooth 28C is provided displaces to the diameter direction outer side), as shown in FIG. 4, the small pawl side engaging tooth 28C engages with the pawl engaging teeth 38A of the sensor holder 38.

A W pawl-limiting portion 28D is provided protruding to the other side in the circumference direction (the opposite side from the direction of arrow C) from an inner side in the diameter direction of an end portion, which is at the other side in the circumference direction, of the small pawl 28. When the small pawl 28 tilts to the other side (the side in the direction of arrow A) in opposition to the urging force of the plate spring 34 with the small pawl support portion 24C of the V gear 24 acting as a spindle, as shown in FIG. 3, the W pawl-limiting portion 28D is disposed in close proximity in the circumference direction with the small pawl-abutting portion 26B of the W pawl 26. Hence, when the small pawl-abutting portion 26B of the W pawl 26 abuts against the W pawl-limiting portion 28D, tilting of the W pawl 26 to the locking position side from the allowing position is limited.

A position of the small pawl 28 in the state in which the W pawl-limiting portion 28D and the small pawl-abutting portion 26B of the W pawl 26 are disposed in close proximity in the circumference direction is referred to as a “W pawl limiting position” (the position shown in FIG. 3), which serves as a first position. A position of the small pawl 28 in the state in which the small pawl side engaging tooth 28C may engage with the pawl engaging teeth 38A of the sensor holder 38 is referred to as a “lock position” (the position shown in FIG. 4), which serves as a second position. A position of the small pawl 28 in a state in which tilting of the small pawl 28 is limited by the urging force of the plate spring 34, which is between the W pawl limiting position and the lock position, is referred to as a middle position (the position shown in FIG. 5). In the state in which the small pawl 28 is disposed at the middle position as shown in FIG. 5, the small pawl side engaging tooth 28C does not engage with the pawl engaging teeth 38A of the sensor holder 38 and the small pawl-abutting portion 26B of the W pawl 26 does not abut against the W pawl-limiting portion 28D.

A magnet 36 is fixed (for example, enclosed) at one side in the circumference direction (the side in the direction of arrow C) of the small pawl 28. A south pole and north pole of the magnet 36 are oriented in the axis direction.

As shown in FIG. 1 and FIG. 2, the coil 30 is provided at one side in the axis direction of the small pawl 28. The coil 30 is formed by winding of a wire member in the circumference direction about the rotation axis of the spool 14. Most of the coil 30 is disposed in a coil accommodation body 40. The coil accommodation body 40 is formed, using a resin material, in a circular plate shape. Electric current is applied to the coil 30 through terminal portions of the coil 30, which are not shown in the drawings and which protrude from the coil accommodation body 40. A portion of the coil 30 in the circumference direction is disposed in close proximity in the axis direction with the circumference direction one side (the side in the direction of arrow C) of the small pawl 28 (with the region in which the magnet 36 is fixed). When electric current is applied to the coil 30 in one direction, the small pawl 28 is tilted toward the W pawl limiting position. When electric current is applied to the coil 30 in the other direction, the small pawl 28 is tilted toward the lock position.

The V gear 24, W pawl 26, small pawl 28, coil 30 and so forth described above are disposed in the sensor holder 38, which is attached to the leg plate 12B of the frame 12. In the state in which the sensor holder 38 is attached to the leg plate 12B of the frame 12, the W pawl 26 and small pawl 28 are disposed to oppose the pawl engaging teeth 38A of the sensor holder 38 in the diameter direction. The pawl engaging teeth 38A serve as an engaged portion.

### Operation and Effects of the Present Exemplary Embodiment

Now, operation and effects of the present exemplary embodiment are described.

As shown in FIG. 1, in the webbing take-up device 10 according to the present exemplary embodiment, the webbing 16 is pulled out from the spool 14 and applied to a vehicle occupant sitting on a vehicle seat. When the vehicle occupant sitting on the vehicle seat removes the applied webbing 16, the spool 14 is rotated in the take-up direction by the take-up urging mechanism, which is not shown in the drawings, and takes up the webbing 16 onto the spool 14.

When a vehicle occupant boarding the vehicle and sitting on the vehicle seat is detected by a sensor, electric current is applied to the coil 30 in the one direction, as shown in FIG. 3. Consequently, the small pawl 28 tilts from the middle position to the W pawl limiting position, and the W pawl-limiting portion 28D of the small pawl 28 and small pawl-abutting portion 26B of the W pawl 26 are disposed in close proximity in the circumference direction. In this state, tilting of the W pawl 26 from the allowing position to the locking position side is limited. Therefore, the vehicle occupant sitting on the vehicle seat may pull out the webbing 16 from the spool 14 quickly and apply the webbing 16. Thus, in the present exemplary embodiment, unnecessary locking of rotation of the spool 14 at a time of application of the webbing 16 may be prevented or suppressed.

In a state in which application of the webbing 16 to the vehicle occupant sitting on the vehicle seat is complete, the application of electric current to the coil 30 is stopped. As a result, the small pawl 28 is tilted from the W pawl limiting position to the middle position by the urging force of the plate spring 34.

When a sensor or the like provided at the vehicle detects that a deceleration of the vehicle exceeds a predetermined deceleration (at a time of emergency of the vehicle or the like), electric current is applied to the coil 30 in the other direction, as shown in FIG. 4. Consequently, the small pawl 28 is tilted from the middle position to the lock position, and the small pawl side engaging tooth 28C engages with the pawl engaging teeth 38A of the sensor holder 38. Hence, rotation of the small pawl 28, which is engaged with the pawl engaging teeth 38A of the sensor holder 38, and of the V gear 24 supporting the small pawl 28 is limited.

In a case in which the body of the vehicle occupant sitting on the vehicle seat moves toward the seat front side due to the deceleration of the vehicle, and the webbing 16 is pulled out from the spool 14, the spool 14 is rotated in the pull-out direction together with the main lock 22. Consequently, the V gear engaging protrusion portion 22A of the main lock 22 moves along the operation slot 24D of the V gear 24 whose rotation is limited (moves in a direction depicted by a two-dot chain line arrow), and the main lock side engaging teeth of the main lock 22 engage with the lock teeth 12E of the frame 12 (see FIG. 1). Hence, rotation of the spool 14 in the pull-out direction is limited and pulling out of the webbing 16 from the spool 14 is limited. Accordingly, the body of the vehicle occupant sitting on the vehicle seat is restrained by the webbing 16.

When the vehicle returns to usual running after a time of emergency, the application of electric current to the coil 30 is stopped. Consequently, the small pawl 28 is tilted from the lock position to the middle position by the urging force of the plate spring 34, the spool 14 is turned in the take-up direction by the take-up urging mechanism that is not shown in the drawings, and the webbing 16 that has been pulled out from the spool 14 is taken up onto the spool 14.

In a state in which electric current cannot be applied to the coil 30 due to a disconnection of wiring or the like, when the vehicle rapidly decelerates and the body of the vehicle occupant sitting on the vehicle seat moves toward the seat front side, the webbing 16 is suddenly pulled out from the spool 14. As a result, the V gear 24 is rotated in the pull-out direction together with the W pawl 26. If the rotation speed of the spool 14 in the pull-out direction exceeds the predetermined speed, centrifugal force acting on the W pawl 26 exceeds the urging force of the coil spring 32. Thus, as shown in FIG. 5, the W pawl 26 tilts from the allowing position to the locking position, and the W pawl side engaging tooth 26C of the W pawl 26 engages with the pawl engaging teeth 38A of the sensor holder 38. Hence, rotation of the W pawl 26, which is engaged with the pawl engaging teeth 38A of the sensor holder 38, and of the V gear 24 supporting the W pawl 26 is limited. Further, when the body of the vehicle occupant sitting on the vehicle seat moves toward the seat front side and the webbing 16 is pulled out further from the spool 14, the spool 14 is rotated in the pull-out direction together with the main lock 22. Therefore, the V gear engaging protrusion portion 22A of the main lock 22 moves along the operation slot 24D of the V gear 24 whose rotation is limited (moves in the direction depicted by the two-dot chain line arrow), and the main lock side engaging teeth of the main lock 22 engage with the lock teeth 12E of the frame 12. Hence, rotation of the spool 14 in the pull-out direction is limited and pulling out of the webbing 16 from the spool 14 is limited. Accordingly, the body of the vehicle occupant sitting on the vehicle seat is restrained by the webbing 16. Thus, in the present exemplary embodiment, even in a state in which electric current cannot be applied to the coil 30, the body of the vehicle occupant sitting on the vehicle seat may be restrained by the webbing 16 at a time of rapid deceleration of the vehicle.

In the present exemplary embodiment, the W pawl 26 and the small pawl 28 are structured to engage with the same pawl engaging teeth 38A disposed at the diameter direction outer side of the W pawl 26 and the small pawl 28. Therefore, an increase in overall size of the webbing take-up device 10 may be suppressed compared to a structure in which portions with which the W pawl 26 and the small pawl 28 engage are provided separately.

In the present exemplary embodiment, the plate spring 34 is provided, which urges the small pawl 28 that has been displaced to the W pawl limiting position side or lock position side thereof to the middle position side thereof. Therefore, in states in which electric current is not being applied to the coil 30, the small pawl 28 may be retained at the middle position simply.

In the present exemplary embodiment, the coil 30 and the magnet 36 fixed to the small pawl 28 are disposed adjacent to each other in the axis direction. Therefore, an increase in overall size of the webbing take-up device 10 in the diameter direction may be suppressed.

In the present exemplary embodiment, a structure is described in which the coil 30 and the magnet 36 fixed to the small pawl 28 are adjacent to each other in the axis direction, but the present invention is not limited thus. For example, the coil 30 and the magnet 36 fixed to the small pawl 28 may be disposed adjacent to each other in the diameter direction.

In the present exemplary embodiment, an example is described in which the plate spring 34 is provided that urges the small pawl 28 that has been displaced to the W pawl limiting position side or the lock position side to the middle position side, but the present invention is not limited thus. For example, a structure is possible that is not provided with the plate spring 34 but returns the small pawl 28 displaced to the W pawl limiting position side or lock position side to the middle position side by switching electrification of the coil 30.

In the present exemplary embodiment, an example is described in which the small pawl 28 is tilted by electric current being applied to the coil 30, but the present invention is not limited thus. For example, the small pawl 28 may be displaced by a mechanical structure utilizing friction or the like.

In the present exemplary embodiment, an example is described in which the W pawl 26 and small pawl 28 engage with the same pawl engaging teeth 38A disposed at the diameter direction outer side of the W pawl 26 and small pawl 28, but the present invention is not limited thus. Structures are possible in which portions with which the W pawl 26 and small pawl 28 engage are provided separately.

### Alternative Embodiment of the Lock Mechanism

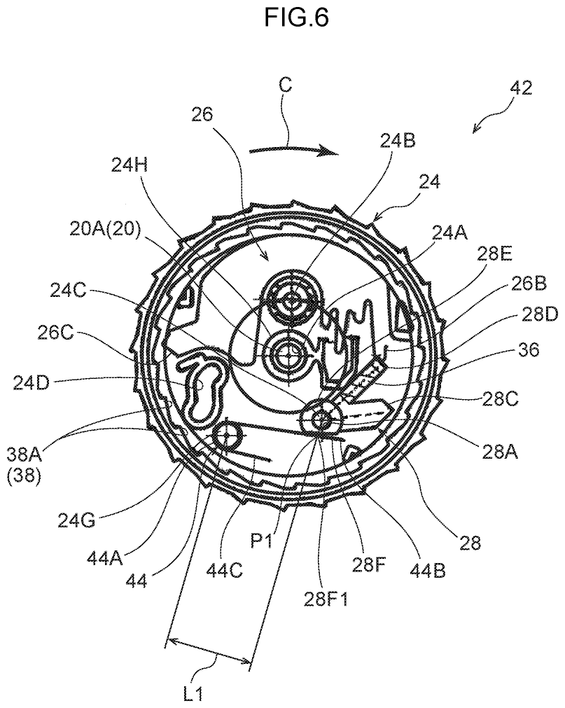

Now, a lock mechanism 42 according to an alternative embodiment is described using FIG. 6 to FIG. 9. Members and portions of the lock mechanism 42 according to the alternative embodiment that correspond with the lock mechanism 18 described above are assigned the same reference symbols as the corresponding members and portions of the lock mechanism 18, and descriptions thereof are not given.

As shown in FIG. 6 to FIG. 8, the lock mechanism 42 according to the present embodiment is characterized by including a small pawl 28, which is formed in a V-shaped block shape, and a torsion coil spring 44, which serves as an urging member urging the small pawl 28 to a middle position side thereof.

A region of the small pawl 28 in which the support hole 28A, through which the small pawl support portion 24C of the V gear 24 is inserted, is formed is a shaft portion 28E that is formed in a substantially circular rod shape. A small pawl side engaging tooth 28C and a W pawl-limiting portion 28D are provided protruding to an outer side in a diameter direction of the shaft portion 28E from an outer periphery face of the shaft portion 28E. One portion of the outer periphery face of the shaft portion 28E is formed as an abutting face 28F with a flat surface shape. A one side end portion 44B of the torsion coil spring 44, which is described below, abuts against the abutting face 28F.

The torsion coil spring 44 is provided with a coil portion 44A, the one side end portion 44B and another side end portion 44C. The coil portion 44A is formed by winding of a wire-shaped member. The one side end portion 44B and the other side end portion 44C protrude from the coil portion 44A to outer sides in a diameter direction of the coil portion 44A. The coil portion 44A of the torsion coil spring 44 is anchored at a coil spring anchoring portion 24G provided at the V gear 24 in a state in which the coil spring anchoring portion 24G is inserted inside the coil portion 44A. The other side end portion 44C of the torsion coil spring 44 is anchored at an anchoring portion provided at the V gear 24, which is not shown in the drawings. The one side end portion 44B of the torsion coil spring 44 abuts against the abutting face 28F of the shaft portion 28E of the small pawl 28 in a state in which the one side end portion 44B is urged in a direction of reducing diameter of the coil portion 44A.

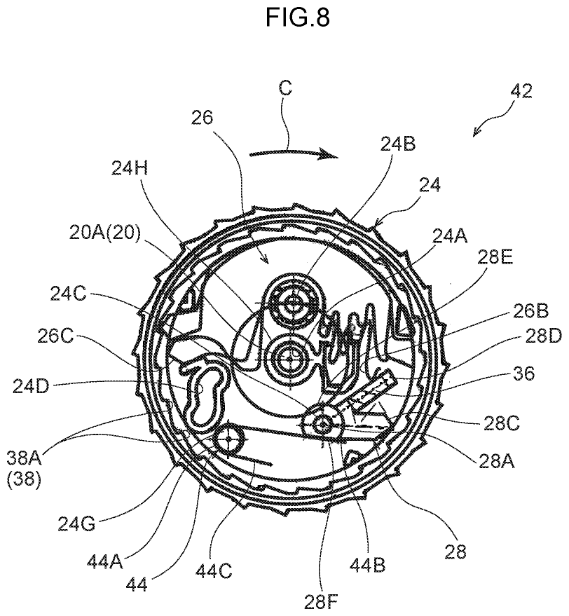

As shown in FIG. 8, in a state in which the small pawl 28 is disposed at a middle position thereof, the abutting face 28F of the shaft portion 28E of the small pawl 28 and the one side end portion 44B of the torsion coil spring 44 are disposed in parallel and are in contact.

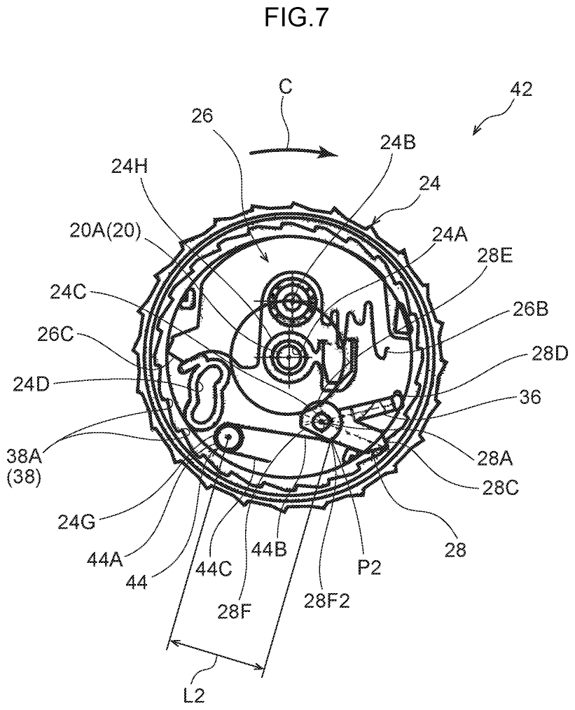

As shown in FIG. 7, when the small pawl 28 is tilted from the middle position to a lock position, the abutting face 28F of the shaft portion 28E of the small pawl 28 inclines to one side while pushing the one side end portion 44B of the torsion coil spring 44. As a result, the one side end portion 44B of the torsion coil spring 44 is displaced in the direction of reducing diameter of the coil portion 44A (a direction away from the abutting face 28F of the shaft portion 28E). In the state in which the small pawl 28 is tilted to the lock position, the one side end portion 44B of the torsion coil spring 44 is in point contact with an end portion 28F2 of the abutting face 28F of the small pawl 28 at the opposite side of the abutting face 28F from the side thereof at which the coil portion 44A of the torsion coil spring 44 is disposed. In this state, a distance from the center of the coil portion 44A to a contact point P2 of the point contact is L2.

As shown in FIG. 6, when the small pawl 28 is tilted from the middle position to a W pawl limiting position, the abutting face 28F of the shaft portion 28E of the small pawl 28 inclines to the other side while pushing the one side end portion 44B of the torsion coil spring 44. As a result, the one side end portion 44B of the torsion coil spring 44 is displaced in the direction of reducing diameter of the coil portion 44A (the direction away from the abutting face 28F of the shaft portion 28E of the small pawl 28). In the state in which the small pawl 28 is tilted to the W pawl limiting position, the one side end portion 44B of the torsion coil spring 44 is in point contact with an end portion 28F1 of the abutting face 28F of the small pawl 28 at the side of the abutting face 28F at which the coil portion 44A of the torsion coil spring 44 is disposed. In this state, a distance from the center of the coil portion 44A to a contact point P1 of the point contact is L1, which is a smaller dimension than the above-mentioned L2 (see FIG. 7).

As shown in FIG. 6 and FIG. 7, in the lock mechanism 42 according to the present embodiment described above, the position of the above-mentioned contact point P2 in the state in which the small pawl 28 is disposed at the lock position is different from the position of the above-mentioned contact point P1 in the state in which the small pawl 28 is disposed at the W pawl limiting position. Therefore, an urging force of the torsion coil spring 44 that is required to return the small pawl 28 to the middle position is provided, but the urging force may be restrained from being excessive.

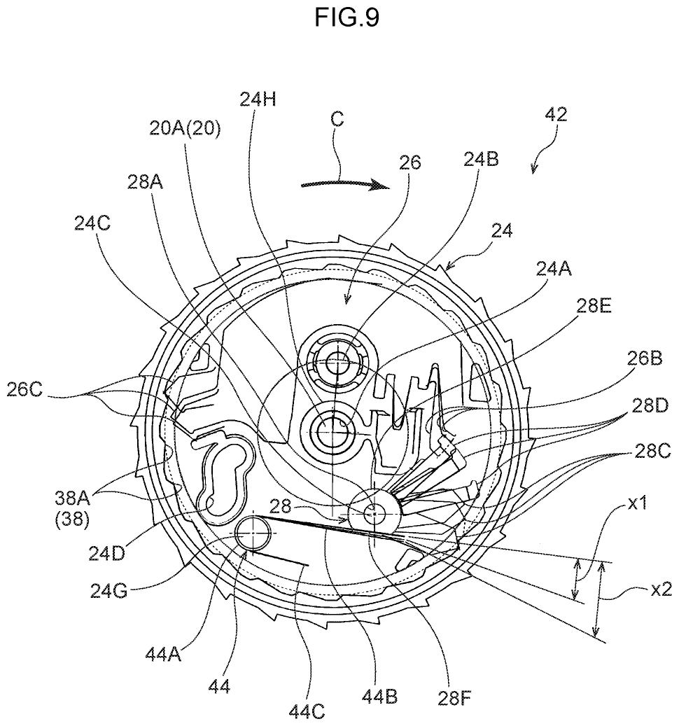

In more detail, because the distance L2 from the center of the coil portion 44A to the contact point P2 is specified to be longer than the distance L1 from the center of the coil portion 44A to the contact point P1, a spring constant k2 in the state in which the small pawl 28 and the torsion coil spring 44 are in contact at the contact point P2 may be smaller than a spring constant k1 in the state in which the small pawl 28 and the torsion coil spring 44 are in contact at the contact point P1. Therefore, as illustrated in FIG. 9, even though an amount x1 by which the one side end portion 44B of the torsion coil spring 44 is displaced from the middle position to the W pawl limiting position of the small pawl 28 is smaller than an amount x2 by which the one side end portion 44B of the torsion coil spring 44 is displaced from the middle position to the lock position of the small pawl 28, an urging force of the torsion coil spring 44 that is required to return the small pawl 28 from the W pawl limiting position to the middle position may be provided. That is, even though the amount x2 by which the one side end portion 44B of the torsion coil spring 44 is displaced from the middle position to the lock position of the small pawl 28 is greater than the amount x1 by which the one side end portion 44B of the torsion coil spring 44 is displaced from the middle position to the W pawl limiting position of the small pawl 28, the urging force of the torsion coil spring 44 returning the small pawl 28 from the lock position to the middle position is restrained from being excessive.

### Alternative Embodiment of the Lock Mechanism

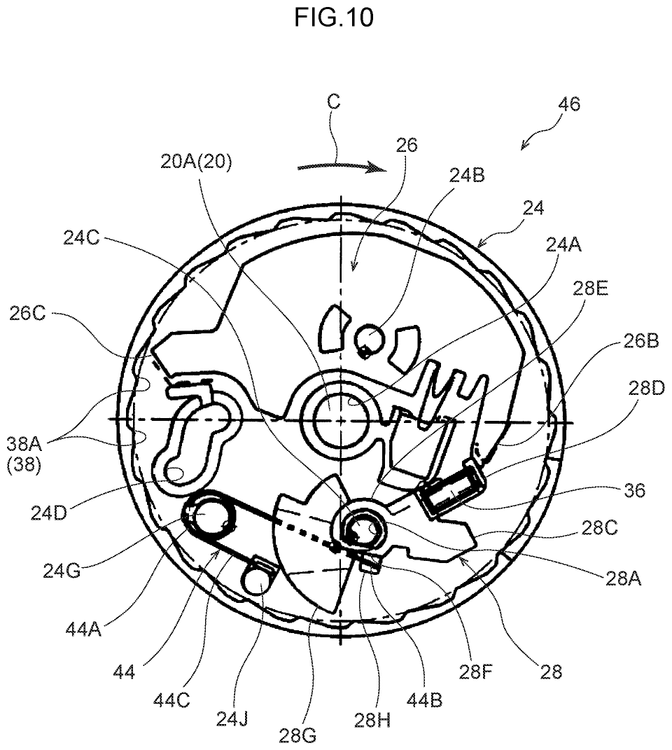

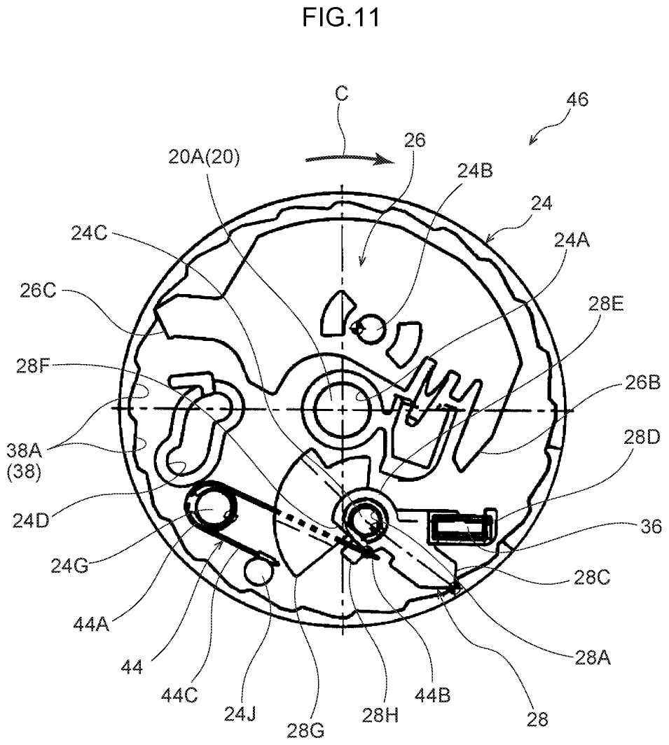

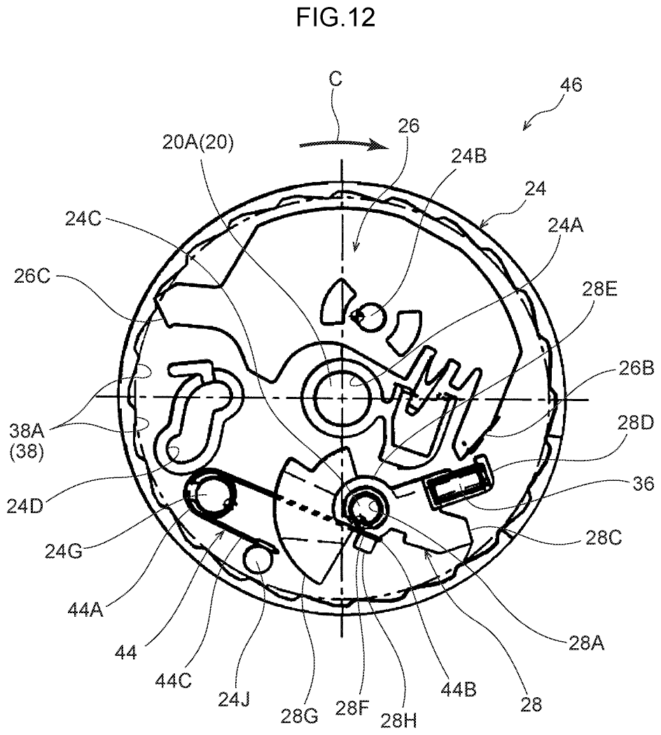

Now, a lock mechanism 46 according to another alternative embodiment is described using FIG. 10 to FIG. 12. Members and portions of the lock mechanism 46 according to the another alternative embodiment that correspond with the lock mechanisms 18 and 42 described above are assigned the same reference symbols as the corresponding members and portions of the lock mechanisms 18 and 42, and descriptions thereof are not given.

As shown in FIG. 10 to FIG. 12, the lock mechanism 46 according to the present embodiment is characterized by a small pawl 28 being provided with a fan plate portion 28G that protrudes from a shaft portion 28E to outer sides in a diameter direction of the shaft portion 28E. The fan plate portion 28G is formed in a hand fan shape as seen in an axis direction and is disposed around the shaft portion 28E at the opposite side of the shaft portion 28E from a side thereof at which a small pawl side engaging tooth 28C and a W pawl-limiting portion 28D are disposed.

At a portion of the shaft portion 28E that corresponds with an abutting face 28F, an anchor protrusion portion 28H, which is formed in a rectangular block shape, protrudes from the shaft portion 28E to the diameter direction outer side. One side end portion 44B of the torsion coil spring 44 is disposed between the fan plate portion 28G and the anchor protrusion portion 28H. Thus, movement of the one side end portion 44B of the torsion coil spring 44 in the axis direction is limited.

An anchor protrusion portion 24J is provided at the V gear 24. Other side end portion 44C of the torsion coil spring 44 is anchored at the anchor protrusion portion 24J.

In the lock mechanism 46 according to the present embodiment, because the fan plate portion 28G is provided, a center of gravity position of the small pawl 28 matches the axial center of the shaft portion 28E (the axial center of the small pawl support portion 24C of the V gear 24). Therefore, torques and centrifugal torque around the shaft portion 28E of the small pawl 28 corresponding to accelerations acting on the lock mechanism 46 may be reduced (substantially to zero). As a result, forces required for tilting the small pawl 28 (magnetic forces from the magnet 36 and the coil 30 (see FIG. 1)) may be reduced. Thus, the magnet 36 may be made smaller, costs may be lowered, a region of the small pawl 28 in which the magnet is provided may be made smaller, and space may be used more efficiently. Because the magnet 36 may be made smaller, the center of gravity position of the small pawl 28 may more easily be brought closer to the side at which the axial center of the shaft portion 28E is disposed, and design of the small pawl 28 may be made easier.

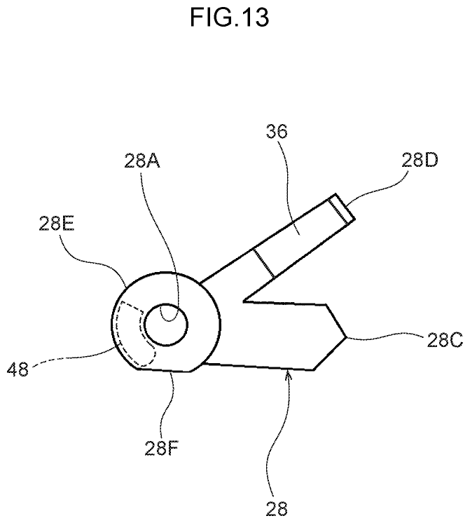

In a structure in which space may not be reserved for providing the fan plate portion 28G, a structure is possible in which a weight 48 is embedded in the shaft portion 28E of the small pawl 28, as illustrated in FIG. 13.

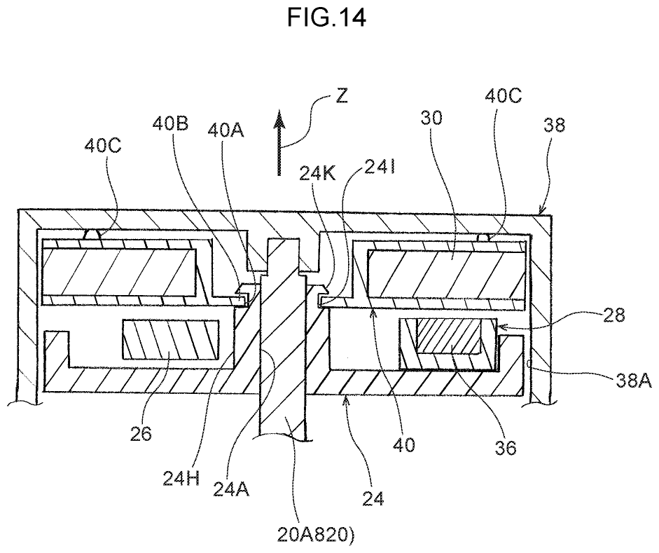

With regard to reducing forces required to tilt the small pawl 28 (magnetic forces from the magnet 36 and the coil 30 (see FIG. 1)) and with regard to improving reliability, meaning robustness and the like of the lock mechanism 18, 42 or 46, it is important to dispose the magnet 36 and the coil 30 close together and it is important to suppress separation between the magnet 36 and the coil 30. Accordingly, in a structure illustrated in FIG. 14, displacement of the coil accommodation body 40 supporting the coil 30 in the axis direction is restricted. Thus, separation of the coil 30 supported at the coil accommodation body 40 from the magnet 36 is suppressed.

In more detail, a circular insertion hole 40A is formed in a spindle center portion of the coil accommodation body 40. A boss portion 24H with a circular tube shape is formed at the center in the diameter direction of the V gear 24. The boss portion 24H includes the support hole 24A. The boss portion 24H is inserted through the insertion hole 40A. A peripheral edge portion 40B of the insertion hole 40A of the coil accommodation body 40 is disposed in an anchor groove 241 formed in an outer periphery portion of the boss portion 24H. Thus, displacement of the coil accommodation body 40 in the axis direction relative to the V gear 24 is restricted. An end portion at the axis direction one side of the boss portion 24H and peripheral edge portions of the anchor groove 241 serve as a pawl portion 24K, which is displaceable to the diameter direction inner sides thereof. When the pawl portion 24K is displaced to the diameter direction inner sides, the boss portion 24H may be inserted into the insertion hole 40A of the coil accommodation body 40, and the peripheral edge portion 40B of the insertion hole 40A may be disposed in the anchor groove 241.

Protrusion portions 40C formed at the coil accommodation body 40 are tightly fitted into depressions formed in the sensor holder 38, which are not shown in the drawings. Thus, rotary displacement of the coil accommodation body 40 relative to the sensor holder 38 is restricted.

Hereabove, exemplary embodiments of the present invention are described. The present invention is not limited by these descriptions and it will be clear that numerous modifications beyond these descriptions may be embodied within a technical scope not departing from the scope of the invention.

The disclosures of Japanese Patent Application Nos. 2019-074161 and 2019-227053 are incorporated into the present specification by reference in their entirety.

All references, patent applications and technical specifications cited in the present specification are incorporated by reference into the present specification to the same extent as if the individual references, patent applications and technical specifications were specifically and individually recited as being incorporated by reference.

1. A webbing take-up device, comprising:
a spool onto which is taken up a webbing that is configured to be applied to a vehicle occupant, the spool being rotated in a pull-out direction by the webbing being pulled out;
a first pawl provided to be integrally rotatable with the spool, the first pawl being displaceable between an allowing position and a locking position, and in a case in which a rotation speed of the spool in the pull-out direction exceeds a predetermined speed, the first pawl being displaced from the allowing position to the locking position and locking rotation of the spool in the pull-out direction; and
a second pawl provided to be integrally rotatable with the spool, the second pawl being displaceable between a first position and a second position,
in a state in which the second pawl is disposed at the first position, the second pawl limiting displacement of the first pawl to a locking position side thereof, and
in a state in which the second pawl is disposed at the second position, the second pawl locking rotation of the spool in the pull-out direction.

2. The webbing take-up device according to claim 1, further comprising an engaged portion disposed at an outer side in a spool diameter direction of the first pawl and the second pawl, the first pawl and the second pawl engaging with the engaged portion, wherein:
the first pawl engages with the engaged portion in a case in which the first pawl is disposed at the locking position; and
the second pawl engages with the engaged portion in a case in which the second pawl is disposed at the second position.

3. The webbing take-up device according to claim 1, further comprising:
a magnet provided at the second pawl; and
a coil disposed to oppose the magnet, wherein:
the second pawl is displaced to the first position by electric current being applied to the coil in one direction, and
the second pawl is displaced to the second position by electric current being applied to the coil in the other direction.

4. The webbing take-up device according to claim 1, wherein the second pawl is disposed at a middle position between the first position and the second position and allows displacement of the first pawl to the locking position side thereof.

5. The webbing take-up device according to claim 4, further comprising an urging member that urges the second pawl that has been displaced to a first position side or a second position side to a middle position side thereof.

6. The webbing take-up device according to claim 3, wherein the coil and the magnet are disposed adjacent to each other in a rotation axis direction of the spool.

7. The webbing take-up device according to claim 4, wherein the first position to which the second pawl displaces is at one side in a spool circumference direction and the second position to which the second pawl displaces is at an opposite side from the one side in the spool circumference direction, relative to the middle position.
